(19) United States
(12) Patent Application Publication
(10) Pub. No.: US 2024/0185366 A1
(43) Pub. Date: Jun. 6, 2024

(54) TECHNOLOGIES FOR COLLECTING PLANT ENVIRONMENT DATA AND ADJUSTING PLANT ENVIRONMENT CONTROLS ASSOCIATED WITH PLANT GROWTH

(71) Applicant: UL LLC, Northbrook, IL (US)

(72) Inventor: Adam Lilien, Syracuse, NY (US)

(21) Appl. No.: 17/797,386

(22) PCT Filed: Jul. 29, 2022
(86) PCT No.: PCT/US2022/038868

§ 371 Date: Feb. 2, 2023

Related U.S. Application Data
(60) Provisional application No. 63/227,760, filed on Jul. 30, 2021.

(51) Int. Cl. G06Q 50/02; A01G 7/04; G01N 21/25; G16Y 10/05

(52) U.S. Cl. CPC G06Q 50/02; A01G 7/045; G01N 21/25; G16Y 10/05

(57) ABSTRACT

Systems and methods for assessing lighting conditions within a growing facility are disclosed. According to certain aspects, a set of light sensors within the growing facility may detect light emitted from a set of light sources, where the light is configured in association with growing a particular plant. An electronic device may compare data generated by the set of light sensors to data indicative of ideal lighting conditions for the particular plant. A user or individual may review a result of the comparison and determine to modify operation of the set of light sources. In embodiments, the electronic device may automatically perform the comparison, and based on a set of conditions established by an operator, determine how to modify operation of the set of light sources and cause the set of light sources to modify operation to better comply with the ideal lighting conditions.

### CROSS-REFERENCE TO RELATED APPLICATIONS

This application claims priority to U.S. Patent Application No. 63/227,760, filed Jul. 30, 2021, the disclosure of which is hereby incorporated by reference in its entirety.

### FIELD

The present disclosure is directed to technologies for collecting lighting data and other data associated with plant growing conditions, and adjusting lighting controls and other conditions associated with plant growth.

### BACKGROUND

There is a growing demand for food across the world, particularly plant-based foods. Facilities such as indoor farms that grow plants in contained environments are prolific to help meet this demand. To yield an ample amount of food, and/or to generally increase output while maintaining the taste, texture, and nutritional value of their products, indoor and outdoor farms typically monitor and adjust various growing conditions in addition to counseling with scientists to ascertain the ingredients (i.e., recipes) that are feeding the crop. Failing to monitor and control one or more conditions can cause crop losses and lead to monetary and/or brand harm (e.g., leading to a grocery store's customers returning produce).

Generally, administrators of indoor and outdoor farms design systems that monitor and control the recipes as well as monitor and control the nutrients, temperature, and carbon dioxide levels. For example, today nutrients are only monitored and controlled by nutrient selection initially mixed to feed the plants, and temperature/humidity and carbon dioxide levels are monitored and controlled by air handling systems. However, there are additional factors that affect plant growth and the quality of the growing plants which are not currently monitored or controlled, such as lighting conditions.

Therefore, there is an opportunity for platforms and techniques for monitoring and controlling lighting conditions in facilities such as indoor farms. Additionally, there is a need to simultaneously monitor and report on multiple potential plant growth factors. Therefore, there is an opportunity for systems, platforms, and techniques for simultaneously monitoring, reporting, and controlling multiple plant growth factors and conditions.

### BRIEF DESCRIPTION OF FIGURES

FIG. 1 depicts an overview of components used in assessing environmental conditions in a plant growing facility, in accordance with some embodiments.

FIG. 2 illustrates a signal diagram of various functionalities for assessing environmental conditions in a plant growing facility, in accordance with some embodiments.

FIGS. 3A and 3B depict example interfaces associated with assessed lighting conditions in a plant growing facility, in accordance with some embodiments.

FIG. 4 illustrates an example flow diagram of assessing lighting conditions in a plant growing facility, in accordance with some embodiments.

FIG. 5 is a hardware diagram of an example server and an example electronic device configured to facilitate the described techniques, in accordance with some embodiments.

### DETAILED DESCRIPTION

Generally, contained plant growing environments such as grow farms or other similar facilities support the cultivation and growing of different types of plants. Conventionally, administrators or technicians associated with these contained environments control the nutrients provided to the plants at the initial stage (i.e., nutrient selection), as well as the temperature and carbon dioxide levels within the contained environments, as these factors tend to affect the growth of the plants. These contained environments do not, however, account for or adjust lighting conditions as they relate to improving plant growth. Generally, lighting conditions are shown to affect different aspects of plant growth. In particular, lighting conditions can affect stem length, leaf color, and/or flowering of plants, among other aspects.

Additionally, conventional systems do not simultaneously monitor, report, or control multiple plant growth factors. If, for example, plants are not getting the necessary light from natural or artificial sources, other plant growth factors may be adjusted to make up for the inadequate lighting (e.g., adding additional nutrients to the plant food).

Plant scientists and other individuals are able to identify which lighting conditions may positively (or negatively) affect plant growth. Accordingly, it is advantageous to adjust actual lighting conditions to meet these identified lighting conditions. Using the recent proliferation of advanced technologies in light sources, such as light emitting diode (LED) bulbs and other elements and features, it is now becoming possible to adjust and control lighting in certain environments with “tunable” lighting. For example, light sources can be adjusted to different light outputs, color temperatures, and/or other characteristics.

Further, certain light sources may claim or be advertised or marketed (e.g., by the manufacturer or retailer) to operate according to specified characteristics (e.g., a specified light output with a specified color temperature). However, the light sources may not actually operate according to these specified, marketed, or advertised characteristics. For example, an LED bulb may output an actual color temperature that deviates from its marketed color temperature.

This may be a result, for example, of a lighting manufacturer measuring and reporting the Spectral Power Distribution (SPD) of the luminaire based on what an engineer(s), scientist(s), or other individual envisioned as an ideal or optimal lighting product. However, a supply chain team, sales team, or other personnel may then modify certain characteristics of the original ideal design or product in order to make the product more affordable for the market, for example. Despite the subsequent change in design, the manufacturer may not then re-test the modified design or product, and instead market or advertise the modified product as performing to the test output measured with the original ideal design. For example, if the original ideal design was tested to have a specific SPD of the luminaire and, after testing, the manufacturer altered the design for the actual product sold in the marketplace, the manufacturer may not re-test and report the new or actual SPD of the luminaire of this altered design, and instead report and market the original ideal results as applicable to the altered, actual product on the market place.

There is thus a need to confirm that light sources and other plant growth components operate in actual real world conditions according to the specifications advertised or marketed by the manufacturers and retailers. Additionally, light sources may degrade or generally change light output behavior over time due to the ages and conditions of the light sources or fixtures. This may be the result, for example, of red LEDs having a longer life than blue LEDs. Over time, this will likely result in a shift in the light output toward the red spectrum. Additionally, a lighting manufacturer of a tunable luminaire might employ algorithms to determine the SPD of the luminaire, but this algorithm may not rely on actual measures of the light output. If an administrator associated with a grow farm or similar facility assumes that light sources operate according to their specified characteristics, but the light sources actually operate differently, it would be useful for the administrator to learn of these differences, especially where they feel that the species of plants is best served by a specific SPD or other characteristic(s) from the luminaires.

The present embodiments as discussed herein address these shortcomings and challenges. In particular, the present embodiments may relate to, inter alia, systems, platforms, and technologies for effectively and efficiently capturing and analyzing data associated with lighting conditions within a controlled environment or facility such as a grow farm. According to certain aspects, systems and methods may incorporate data capture components such as light sensors to capture relevant lighting condition data within the environment. The systems and methods may compare the captured lighting condition data (in situ) to ideal lighting condition data specified in association with a plant(s) being grown within the environment (which may be supplied by the manufacturer).

The systems and methods may also include other data capture components and sensors for monitoring additional or other factors that may affect plant growth, including fertilizer, nutrient, water, soil moisture, nitrogen, and/or CO2 levels, temperature, relative humidity, air pollution, wind, and/or atmospheric pressure. The systems and methods may compare the captured plant growth data to ideal plant growth data specified in association with a plant(s) being grown within the environment, including, for example, weight of plant, temperature of leaf, nutrient content within the plant (e.g., nitrogen, carbon, hydrogen, phosphorus, potassium, etc.), and/or other measurable data. The systems and methods may then alter or adjust certain factors to make up for any identified deficiencies.

According to aspects, the systems and methods may generate and transmit communications and alerts indicating any differences between captured lighting conditions and ideal or specified lighting conditions. In this regard, an administrator may be notified of or may review deficiencies in the lighting conditions and determine how to adjust the lighting conditions such that lighting conditions may be improved. According to some embodiments, the systems and methods may automatically determine, based on detected lighting conditions, how to adjust one or more light sources or other plant growth factors in the environment, and then cause the one or more light sources or other plant growth factors to adjust operation such that lighting conditions may be improved or otherwise adjusted to meet the specified lighting conditions or such that other conditions may be improved to compensate for any identified deficient lighting conditions.

The systems and methods offer numerous benefits and improvements. In particular, the systems and methods effectively and efficiently determine, assess, and communicate or avail deficiencies in lighting conditions that affect plant growth. Accordingly, individuals associated with growing facilities may effectively and efficiently assess lighting deficiencies and facilitate modifications to address the lighting deficiencies. Because the lighting conditions are able to be captured in real-time or near-real-time, the individuals are able to take prompt action to improve conditions. Further, individuals may access (e.g., through a user interface via the cloud) controls to adjust conditions accordingly. Additionally or alternatively, the systems and methods may support automatically determining how to adjust or modify lighting conditions based on any assessed deficiencies, and automatically controlling a set of lights or other controllable plant growth factors accordingly. The plants, thus, may experience better growing conditions which may result in stronger, healthier plants, among other effects. Similarly, the growing facilities may experience a larger and/or better plant output, which may increase revenue and reduce costs. Additionally, the systems and methods incorporate components that may measure and monitor environmental conditions and detect issues. For example, sensors such as nutrient sensors for a liquid nutrient bath (i.e., feeding plant roots from a tub) or in outdoor soil may measure the degradation of certain component nutrients and enable administrators to take corrective or mitigating actions. It should be appreciated that other benefits and improvements are envisioned.

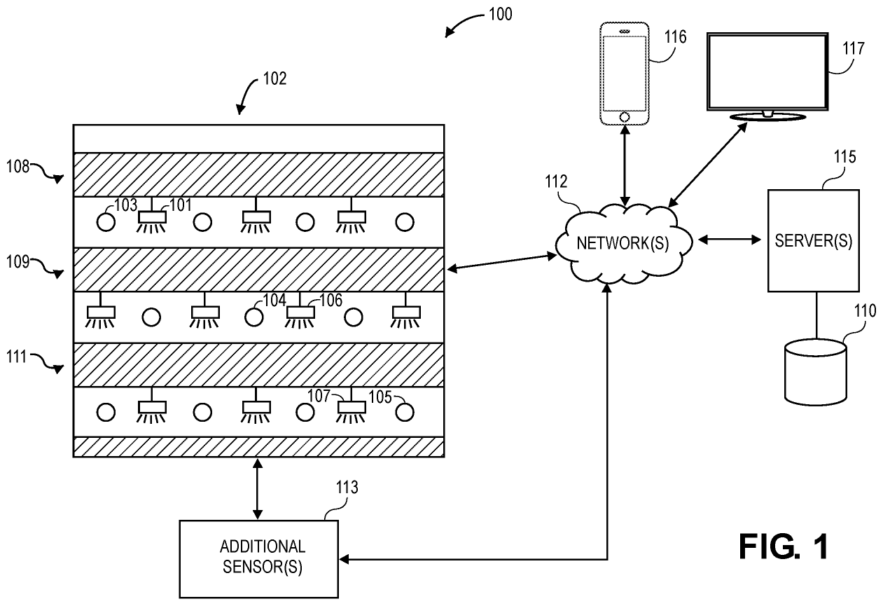

FIG. 1 illustrates an overview of a system 100 of components configured to facilitate the systems and methods. It should be appreciated that the system 100 is merely an example and that alternative or additional components are envisioned. Generally, the system 100 may be associated with a facility, enclosure, area, farm, or the like in which various crops, plants, greenery, vegetation, or the like (generally, “plants”) may be planted, grown, harvested, and/or the like.

As depicted in FIG. 1, the system 100 may include an area 102 in which plants may be planted, grown, and/or harvested. For example, the area 102 may be a “grow farm” in which various plants may be grown in rows (i.e., horizontally), stacks (i.e., vertically), and/or a combination thereof. As depicted in FIG. 1, a set of rows 108, 109, 111 may be established in which respective sets of plants may be grown. It should be appreciated that different (or the same) plants may be planted in different rows, stacks, and combinations thereof. For example, romaine lettuce may be grown in the row 108 and kale may be grown in the row 109.

The area 102 may be configured with a set of light sources that may illuminate various portions of the area 102, where the set of light sources may be electrically or battery powered, may be natural light sources (e.g., windows, skylights, the sun, etc.), or may be a combination of electric or battery powered lights and natural light sources. For example, if the area 102 is a grow farm or other controlled-growth environment, the set of light sources may be luminaires arranged in a linear fashion to illuminate the rows of plans, and/or may be disposed along vertical racks to illuminate the rows of plans growing in the racks and/or may include sky lights. As depicted in FIG. 1, a set of light sources 101, 106, 107 may be disposed in a vicinity of where plants may be grown.

The set of light sources may be configured to emit light in various intensities, wavelengths, spatial ranges, and/or the like, where the characteristics of the emitted light may be a fixed SPD (default) or may be configurable, for example by an administrator of the system 100. According to embodiments in which a set of characteristics is configurable, an administrator of the system 100 may specify the anticipated characteristics of the emitted light, such as to match “recipes” or configurations that intend to optimize or improve the growth of the respective plants illuminated by the set of light sources. It should be appreciated that the characteristics of the emitted light may be default configurations, specified by an administrator, or determined by components of the system 100. For example, romaine lettuce may have a first spectral power distribution (SPD) that represents ideal lighting conditions for growing the romaine lettuce, and kale may have a second SPD that represents ideal lighting conditions for growing the kale. In addition, in a configurable system, a single species may have multiple desired SPDs depending on a stage of growth for the plant, for example one or more SPDs for the “seedling” stage, another for the “growth” stage, another for the “flowering” stage, and yet another for the “harvesting” stage.

According to embodiments, the area 102 may be configured or outfitted with a set of light (i.e., illuminance) sensors. As depicted in FIG. 1, the set of light sensors may include light sensors 103, 104, 105 that are disposed in different rows or sections of the area 102. It should be appreciated that fewer or additional light sensors are envisioned, where the light sensors may be located or disposed at various locations or in various configurations throughout the area 102. As depicted in FIG. 1, the light sensor 103 is disposed in a vicinity of the light source 101, the light sensor 104 is disposed in a vicinity of the light source 106, and the light sensor 105 is disposed in a vicinity of the light source 107.

According to embodiments, each light sensor 103, 104, 105 may be configured to sense or detect various properties of light in respective vicinities of the light sensors 103, 104, 105. For example, each light sensor 103, 104, 105 may be configured to detect a luminous intensity (i.e., candela), luminous flux (i.e., lumen), illuminance (i.e., lux), and/or an SPD. In detecting SPD values, each light sensor 103, 104, 105 may capture, at its respective location in the area 102, a respective set of SPD values that may indicate the power (or strength) of each wavelength of light produced by a particular light source(s) including luminaire(s), windows, and/or skylights, at that location, and from which the luminance and chromaticity of a color may be derived.

The system 100 may be further configured with a server(s) 115 and one or more networks 112, where each of the light sensors 103, 104, 105 (as well as the other light sensors) may be communicatively connected to the server(s) 115 via the network(s) 112. In an implementation, the server(s) 115 may be located in the same physical space or vicinity as the area 102. In another implementation, the server(s) 115 may be located remote from the light sensors 103, 104, 105 (i.e., in a cloud computing environment), in which case the light sensors 103, 104, 105 may communicate with a router or access point (not shown in FIG. 1) via the network(s) 112, and the router or access point may communicate with the server(s) 115 via the network(s) 112. In this configuration,

In embodiments, the network(s) 112 may support any type of data communication via any standard or technology (e.g., GSM, CDMA, VOIP, TDMA, WCDMA, LTE, EDGE, OFDM, GPRS, EV-DO, UWB, Internet, IEEE 802 including Ethernet, WiMAX, Wi-Fi, Bluetooth, and others). The server(s) 115 may be associated with an entity such as a company, business, corporation, or the like, and may interface with or support a memory or storage 110 capable of storing various data including any collected or generated data, such as in one or more databases or other forms of storage. In an implementation, each of the light sensors 103, 104, 105 may be communicatively connected to a database that is local to the light sensors 103, 104, 105 (not shown in FIG. 1).

The system 100 may further include a set of electronic devices 116, 117 which may also be communicatively connected to the server(s) 115 via the network(s) 112. Each of the electronic devices 116, 117 may be any type of electronic device such as a mobile device (e.g., a smartphone), desktop computer, notebook computer, tablet, phablet, cloud computer, GPS (Global Positioning System) or GPS-enabled device, smart watch, smart glasses, smart bracelet, wearable electronic, PDA (personal digital assistant), pager, virtual reality (VR) headset, computing device configured for wireless communication, and/or the like.

In embodiments, each of the electronic devices 116, 117 may support an application that may access, read, process, and analyze data recorded and compiled by the light sensors 103, 104, 105 and/or analyzed by the server(s) 115. Further, in embodiments, a user(s) may operate the electronic devices 116, 117 (e.g., via the application) to review various portions of the data. In particular, a user interface(s) of the electronic devices 116, 117 may present a visual rendering of the data captured by the light sensors 103, 104, 105. Thus, the user(s) may review the presented information to assess deficiencies and determine how to improve the lighting conditions associated with the area 102. Additionally, the user(s) may select to add, remove, and modify certain aspects of the light sources, the light sensors 103, 104, 105, and/or other components of the system 100. For example, the user(s) may select to modify characteristics of the light sources in response to determining that sets of SPDs values (or other characteristics) detected by the light sensors 103, 104, 105 do not meet certain threshold values or certain conditions.

The system 100 as depicted in FIG. 1 may additionally include a set of additional sensors 113 that may be disposed or incorporated into different locations or components of the area 102, and that may be configured to monitor additional or other factors that may affect plant growth. In particular, the additional sensor(s) 113 may be configured to sense and monitor levels and conditions related to fertilizers, nutrients, water, soil moisture, nitrogen, and/or CO2, temperature, relative humidity, air pollution, wind, and/or atmospheric pressure. The additional sensor(s) 113 may generate respective sensor data at location(s) at which the additional sensor(s) are disposed or positioned. The additional sensor(s) 113 may communicate with the server(s) 115 and/or the electronic devices 116, 117 via the network(s) 112 in a manner similar to how the light sensors 103, 104, 105 communicate.

In certain conventional implementations, aircraft may fly over fields growing crops to detect the amount of nitrogen in the plants using spectroscopy. According to the present embodiments, the additional sensor(s) 113 may include multiple nitrogen sensors disposed or deployed throughout the area 102 to detect respective nitrogen levels at the respective locations. Additionally, the nitrogen sensors may continuously monitor and transmit the detected nitrogen levels, for example periodically or in real-time or near-real-time. It should be appreciated that the nitrogen sensors may be used in combination with aircraft/drones that employ spectroscopy to measure nitrogen.

As discussed herein, conventional plant growing facilities or environments monitor and control a limited number of environmental conditions that are responsible for plant grown quality, including CO2 levels, air temperature, and humidity. With the light sensors 103, 104, 105 and the additional sensor(s) 113, the components of the system 100 are capable of monitoring, reporting, and controlling some or all of these environmental conditions holistically or in certain combinations. Further, the components of the system 100 may be configured to monitor, report, and control these various environmental conditions at periodic intervals (e.g., once/day, twice/week, etc.), or continuously in real-time or near-real-time. Moreover, components of the system 100 may advantageously generate and communicate alerts or other communications related to the conditions within the facility or environment, to appropriate administrators or other individuals, continuously in real-time or near real-time and/or when certain threshold conditions are met.

Alternatively or additionally, the additional sensor(s) 113 may be a sensor that, in real-time or near-real-time, can monitor the nutrient intake of the plants at different or multiple locations in the area 102, where the nutrient sensor(s) may measure and monitor multiple nutrient conditions or compounds. Conventional sensors measure nutrients by pulling known, “pure” liquid samples into a measuring device and also by pulling in the actual liquid from liquid baths of the plant, and by comparing the actual liquid bath sample to the known “pure” sample and determining the difference. If the actual liquid bath has less nutrients than the known “pure” sample, nutrients can be added one at a time as needed.

In contrast, one or more nutrient sensors as contemplated by the present embodiments may, in addition to monitoring nutrients in liquid baths, monitor nutrient conditions at other locations or components of the system 100 and the area 102. In particular, the one or more nutrient sensors may monitor nutrients or combinations or nutrients at the leaves of plants, in the ground water or base water supply, or in other locations or components. Further, the present embodiments contemplate automatically adding (or preventing from adding) different combinations of nutrients to the appropriate components of the plant growing environment based on the condition data as sensed and monitored.

Although depicted as a single database 110, a single server 115, and two (2) electronic devices 116, 117 in FIG. 1, it should be appreciated that different amounts of databases, servers, and electronic devices are envisioned. Additionally, the components of the system 100, including the sensors 103, 104, 105, the additional sensor(s) 113, the electronic devices 116, 117, the server(s) 115, and the network(s) 112 may be interconnected in an internet of things (IOT) arrangement.

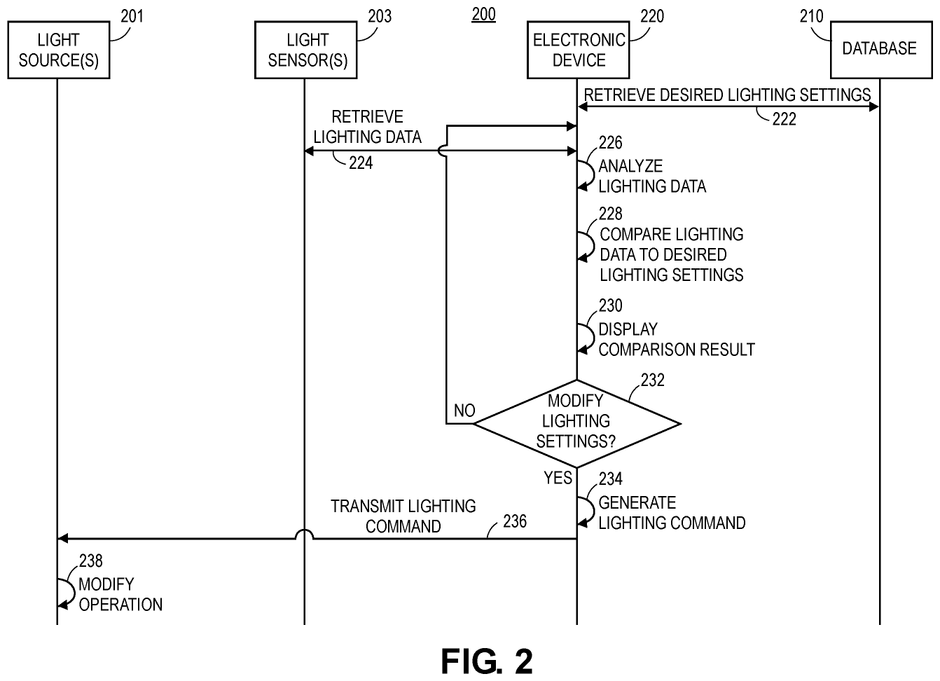

FIG. 2 illustrates a signal diagram 200 comprising a set of components and illustrating various functionalities that may be facilitated by the set of components. The signal diagram 200 includes one or more light sources 201 (such as the light source 101 as described with respect to FIG. 1), one or more light sensors 203 (such as the light sensor 103 as described with respect to FIG. 1), an electronic device 220, and a database 210 (such as the database 110 as described with respect to FIG. 1). According to embodiments, the light source(s) 201 may be electrically or battery powered light source(s), may be a natural light source(s), or may be a combination of electric or battery powered light source(s) and natural light source(s). The light source(s) 201 may be positioned in a facility or area in which one or more different plants may be planted and grown, and the light sensor(s) 203 may be disposed in a vicinity of the light source(s) 201 and the one or more different plants, and may be configured to sense different characteristics and properties of the lighted emitted by the light source(s) 201.

According to embodiments, the electronic device 220 may be a server (such as the server 115 as described with respect to FIG. 1), or another electric device (such as one of the electronic devices 116, 117 as described with respect to FIG. 1). It should be appreciated that the functionalities performed by the electronic device 220 as described in FIG. 2 may be performed by a combination of electronic devices. For example, some of the functionalities may be performed by a server and some of the functionalities may be performed by another electronic device that communicates with the server.

At step 222, the electronic device 220 may retrieve, from the database 210, a set of desired lighting settings, configurations, values, or the like. According to embodiments, the set of desired lighting settings may be a default set of lighting settings or may be specified/saved by a user or administrator. The set of desired lighting settings may correspond to or be associated with the optimum or ideal growing conditions for a particular plant or set of plants, where the set of desired lighting settings may be in the form of a set of SPDs (i.e., a set of graphs of the energy levels of a light source through a range of wavelengths of light), or another measure, specification, characteristic, distribution, or the like. For example, a kale plant may have a first SPD that intends to ensure optimal growth of the kale plant; and a basil plant may have another SPD that intends to ensure optimal growth of the basil plant. In embodiments, the electronic device 220 may additionally retrieve, from the database 210 or another source, characteristics of the light source(s) 201 which may control how the light source(s) 201 operate as well as influence the appearance or characteristics of the light emitted by the light source(s) 201.

The electronic device 220 may retrieve (224), from the light sensor(s) 203, lighting data, where the lighting data may be indicative of various characteristics or properties of the light emitted by the light source(s) 201, and/or any other light that is sensed by the light sensor(s) 203. According to embodiments, the lighting data may be in the form of an SPD captured by each of the light sensor(s) 203. It should be appreciated that the electronic device 220 may retrieve the lighting data at periodic intervals (e.g., once/minute), or the light sensor(s) 203 may continuously provide the lighting data to the electronic device 220 automatically, at periodic intervals or in real-time or near-real-time.

Although referred to as the light sensor(s) 203 in FIG. 2, it should be appreciated that 203 may alternatively or additionally represent additional sensor(s) (such as the additional sensor(s) 113 as discussed with respect to FIG. 1). For example, 203 may represent carbon dioxide (CO2) sensors, temperature sensors, humidity sensors, barometers, and/or the like. Accordingly, the electronic device 220 may retrieve the appropriate sensor data from the additional sensor(s) at periodic intervals (e.g., once/minute), or the additional sensor(s) 203 may continuously provide the appropriate sensor data to the electronic device 220 automatically, at periodic intervals or in real-time or near-real-time.

The electronic device 220 may analyze (226) the lighting data retrieved from the light sensor(s) 203. According to embodiments, the electronic device 220 may compile or group the different lighting data from different light sensor(s) 203, may extract certain properties or characteristics from the lighting data (e.g., may extract one or more SPDs from the lighting data), may convert any portion of the lighting data, and/or may perform other data analyses on the lighting data. For example, the electronic device 220 may determine or extract a first SPD for a first given light sensor 203 and may determine or extract a second SPD for a second given light sensor 203.

The electronic device 220 may compare (228) the lighting data to the set of desired lighting settings retrieved in (222). In an implementation, the electronic device may compare SPD(s) from the lighting data to SPD(s) included in the set of desired lighting settings, where the electronic device 220 may compare the SPD values at different wavelengths, and where the comparison may include a set of differences in the SPD in the lighting data to the SPD in the desired lighting setting for different wavelengths. For example, the comparison may indicate that at a wavelength of 600 nm, the actual SPD value is 60% of relative energy where the desired SPD value is 70% of relative energy. In comparing the lighting data to the set of desired lighting settings, the electronic device 220 may calculate absolute or relative (i.e., percentage) differences between SPD values at different wavelengths (or other characteristics), and compare the calculated differences to desired threshold amounts, which may be default or specified by an administrator.

The electronic device 220 may display (230) a result of the comparison performed in (228). According to embodiments, the electronic device 220 may generate a visualization that may indicate differences between the lighting data retrieved in (224) and the desired lighting settings retrieved in (222), where the visualization may be a combination of text, numbers or values, charts, graphs, lists, and/or the like. Further, the electronic device 220 may display the visualization (or information) in a user interface for review by a user or administrator, or may transmit or send the visualization (or information) to another electronic device (e.g., a smartphone or other device) for display or presentation on that other electronic device. Accordingly, a user or administrator may review the visualization and the information included therein to assess the lighting conditions and aspects thereof, including any differences identified between the lighting conditions and the desired lighting settings. In another embodiment, the electronic device 220 may calculate the difference(s) between the lighting data retrieved in (224) and the desired lighting settings retrieved in (222), compare the difference(s) to an allowable variance or other threshold that is default or set by an administrator; and when the difference(s) exceeds the allowable variance or other threshold, the electronic device 220 may generate and send an alert to an operator or administrator for mitigation.

The electronic device 220 may determine (232) whether to modify any lighting settings. In embodiments, the determination may be based on the comparison of the lighting data to the desired lighting settings, and specifically on whether a difference between the lighting data and the desired lighting settings at least meets a threshold value or percentage. In particular, if a portion of the lighting data differs from a corresponding portion of the desired lighting settings by a threshold value or percentage, then the electronic device 220 may determine to modify a corresponding lighting setting.

For example, an SPD of the desired lighting setting may indicate a percentage of relative energy of 50% at a 700 nm wavelength, an SPD of the lighting data may indicate a percentage of relative energy of 35% at the 700 nm wavelength, and the threshold value may be 10%. Because the SPD of the lighting data differs from the SPD of the desired lighting settings by greater than 10%, the electronic device 220 may determine to modify the lighting settings, and or may determine to generate and send an alert. It should be appreciated that different thresholds and/or conditions for determining whether to modify any lighting settings or to generate and send an alert are envisioned.

According to embodiments, a user or individual associated with the electronic device 220 or another electronic device may request to modify the lighting settings. In particular, the user or individual may request to modify the lighting settings after reviewing the comparison result as generated and displayed in (230). For example, the user or individual may determine that an SPD of the lighting data differs from a desired SPD, and may request that the corresponding lighting settings be modified. In an implementation, the user or individual (or another individual such as a technician) may take steps to modify the lighting settings accordingly.

If the electronic device 220 determines to not modify the lighting settings (“NO”), processing may return to (224), may proceed to other functionality, or may end. If the electronic device 220 determines to modify the lighting settings (“YES”), or to send an alert, processing may proceed to (234) in which the electronic device 220 may generate a lighting command.

In generating the lighting command, the electronic device 220 may initially determine how to modify the settings of the light source(s) 201, which may be based on the difference(s) between the lighting data retrieved in (224) and the desired lighting settings retrieved in (222), as well as any characteristics or components of the light source(s) 210 themselves. In particular, if the lighting data indicates an emitted relative power at a given wavelength that is less than (or more than) the emitted relative power at the given wavelength as specified by the desired lighting settings, the electronic device 200 may determine to adjust components or properties of the light source(s) 201 such that the light source(s) 201 emits more (or less) light at the given wavelength.

According to embodiments, the electronic device 220 may have access to or may determine the relative locations of the light source(s) 201 and the light sensor(s) 203. Additionally, the light source(s) 201 and/or light sensor(s) 203 may be located by beacons, or may incorporate technologies that are self-locating and capable of sending its location(s) to the electronic device 220. Additionally, the electronic device 220 may have access to or may determine which light source(s) 201 and which light sensor(s) 203 are located in proximity to which plants (i.e., which light source(s) 201 will affect the growth of which plants). Accordingly, the electronic device 220 may determine which light source(s) 201 to adjust and accordingly which light sensor(s) 203 will sense adjusted light and, because each plant or groups of plants has an associated desired lighting setting (e.g., in the form of an SPD), the electronic device may determine 220 which plants will be affected by the lighting adjustments and how the plants will be affected by the lighting adjustments.

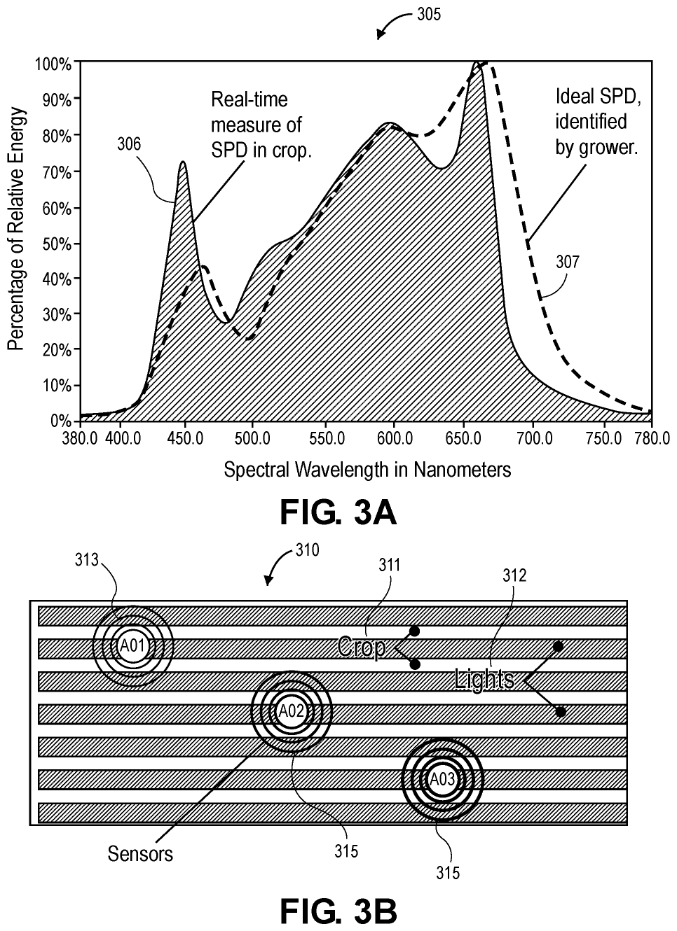

FIGS. 3A and 3B illustrate different visualizations associated with the present embodiments. It should be appreciated that the visualizations as illustrated in FIGS. 3A and 3B may be displayed or presented on an electronic device, such as one of the set of electronic devices 116, 117.

FIG. 3A illustrates a visualization 305 depicting SPD values/curves. The x-axis of the visualization 305 is a range of spectral wavelength measured in nanometers (as shown: 380.0-780.0 nm), and the y-axis of the visualization 305 is a range of percentage of relative energy measured at the corresponding spectral wavelength (as shown: 0%-100%). It should be appreciated that the depicted wavelengths are not limits of the wavelengths that may impact plant growth, and that non-visual wavelengths (i.e., below 380 nm and above 780 nm) may be accounted for in measured and ideal SPD values/curves.

The visualization 305 includes two SPD curves: a measured SPD curve 306 and an ideal SPD curve 307. According to embodiments, the ideal SPD curve 307 may be associated with a particular plant, where the ideal SPD curve 307 includes percentages of relative energy values across different wavelengths, and where the percentages of relative energy values may represent values that may represent ideal growing conditions for the particular plant that may lead to plants having ideal qualities or characteristics (i.e., ideal size, flowers, fruits, etc.). Further, the measured SPD curve 306 may be determined or calculated from lighting conditions that are measured (e.g., by a set of light sensors) in association with growth of a particular plant having the corresponding idea SPD curve 307.

According to embodiments, the percentages or relative energy values of the ideal SPD curve 307 may be specified for the particular plant, either by a grower (or another individual) associated with the plant or generated by an electronic device as a result of one or more analyses of growing conditions and results for the particular plant. For example, a given electronic device may train a machine learning model with training data that may include growing conditions (e.g., lighting data) and results of growing (e.g., size of plants, growing times, etc.). The electronic device may input, into the machine learning model, an identification of a given plant and any available growing conditions (e.g., type of facility, available light sources, etc.), and the machine learning model may output an ideal SPD curve for the given plant.

As depicted in FIG. 3A, the visualization 305 depicts a set of differences between the measured SPD curve 306 and the ideal SPD curve 307 across different spectral wavelengths. For example, at a wavelength of about 440 nm, the measured percentage of relative energy indicated in the measured SPD curve 306 is about 70%, which compares to a percentage of relative energy of about 30% as indicated in the ideal SPD curve 307 (i.e., the measured SPD at 440 nm is much higher than the ideal SPD at 440 nm). For further example, at a wavelength of about 700 nm, the measured percentage of relative energy indicated in the measured SPD curve 306 is about 10%, which compares to a percentage of relative energy of about 30% as indicated in the ideal SPD curve 307 (i.e., the measured SPD at 700 nm is much lower than the ideal SPD at 700 nm).

An individual reviewing the visualization 305 may effectively and efficiently ascertain or identify differences between the measured SPD curve 306 and the ideal SPD curve 307, such as to identify how to modify different lighting settings for different light sources. For example, if a measured SPD value is lower (or higher) than a corresponding ideal SPD value, the light source may need to be modified to cause an increase (or decrease) to the measured SPD value to more closely align with the corresponding ideal SPD value.

FIG. 3B illustrates an overhead visualization 310 depicting representations of a set of crops (plants) 311, a set of light sources 312, and a set of light sensors 313, 314, 315. An electronic device(s) may be configured to generate, transmit/communicate, and/or display/present the visualization 310, in particular for review by a user or administrator. In embodiments, the visualization 310 may indicate differences between measured SPD values and ideal SPD values, as detected by the set of light sensors 313, 314, 315, such as by different designs, colors, shapes, text, and/or the like. For example, if a given light sensor measures an SPD value that is within 10% of an ideal SPD value, that light sensor may be highlighted with a green color; if a given light sensor measures an SPD value that is between 10%-30% of an ideal SPD value, that light sensor may be highlighted with a yellow color; and if a given light sensor measures an SPD value that differs from an ideal SPD value by more than 30%, that light sensor may be highlighted with a red color.

Accordingly, an individual reviewing the visualization 310 may effectively and efficiently ascertain or identify which plants (and area sections) within the facility or area are not receiving ideal light for growing the corresponding plants. Accordingly, the individual may effectively and efficiently determine whether and how to adjust the light sources in that area section(s) to improve the light emission to better comply with the ideal SPD curve. Additionally or alternatively, the individual may effectively and efficiently determine whether and how to send an alert to an administrator of the growing facility which may enable the administrator to, for example, check the current lighting source and determine if changes need to be made, including replacing the source with a new light source of the same type or a different type or adding another source.

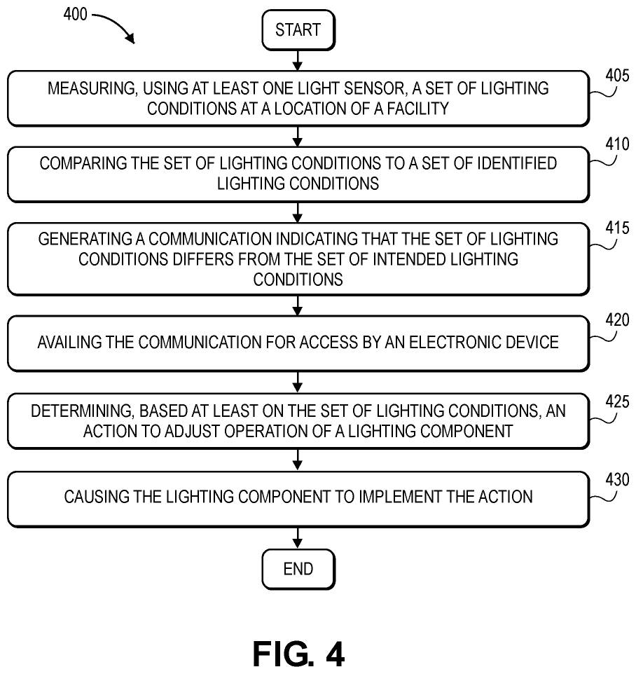

FIG. 4 is a flowchart of a method 400 for assessing lighting conditions within a facility in which plants are grown. The method 400 may be executed or implemented by one or more electronic devices and components thereof. For example, the method 400 may be executed or implemented by one or more of the server 115 or one of the set of electronic devices 116, 117.

The method 400 may begin at block 405 when the electronic device(s) measures, using at least one light sensor, a set of lighting conditions at a location of a facility. According to embodiments, the set of lighting conditions may be a spectral power distribution (SPD) at the location of the facility.

At block 410, the electronic device(s) may compare the set of lighting conditions to a set of intended lighting conditions. According to embodiments, the set of intended lighting conditions may be an intended or desired SPD. Further, in comparing the set of lighting conditions to the set of intended lighting conditions, the electronic device(s) may determine that one or more aspects of the set of lighting conditions differs from one or more aspects of the set of intended lighting conditions by a threshold amount.

At block 415, the electronic device(s) may generate a communication indicating that the set of lighting conditions differs from the set of intended lighting conditions. In embodiments, the electronic device(s) may generate a visualization illustrating a set of differences between the set of lighting conditions and the set of intended lighting conditions.

At block 420, the electronic device(s) may avail the communication for access by the same electronic device(s) or a separate electronic device. According to embodiments, the electronic device(s) may display the communication in a user interface of the electronic device(s). Additionally or alternatively, the electronic device(s) may send the communication to a separate electronic device, which may access the communication and may display or present the communication (e.g., in a user interface). In some embodiments, the communication may be in the form of an alert that the electronic device(s) may available for access or otherwise send to another electronic device of an administrator or other individual.

At block 425, the electronic device(s) may determine, based at least on the set of lighting conditions, an action to adjust operation of a lighting component. In embodiments, the electronic device(s) may receive, via the electronic device(s), a selection to adjust the operation of the lighting component, and may generate, based on the selection, the action to adjust the operation of the lighting component. Further, in embodiments, the electronic device(s) may automatically determine the action to adjust operation of the lighting component, or may determine to send an alert.

At block 430, the electronic device(s) may cause the lighting component to implement the action. According to embodiments, the electronic device(s) may generate and transmit a command associated with the action to the lighting component, wherein the lighting component executes the command to cause the lighting component to implement the action.

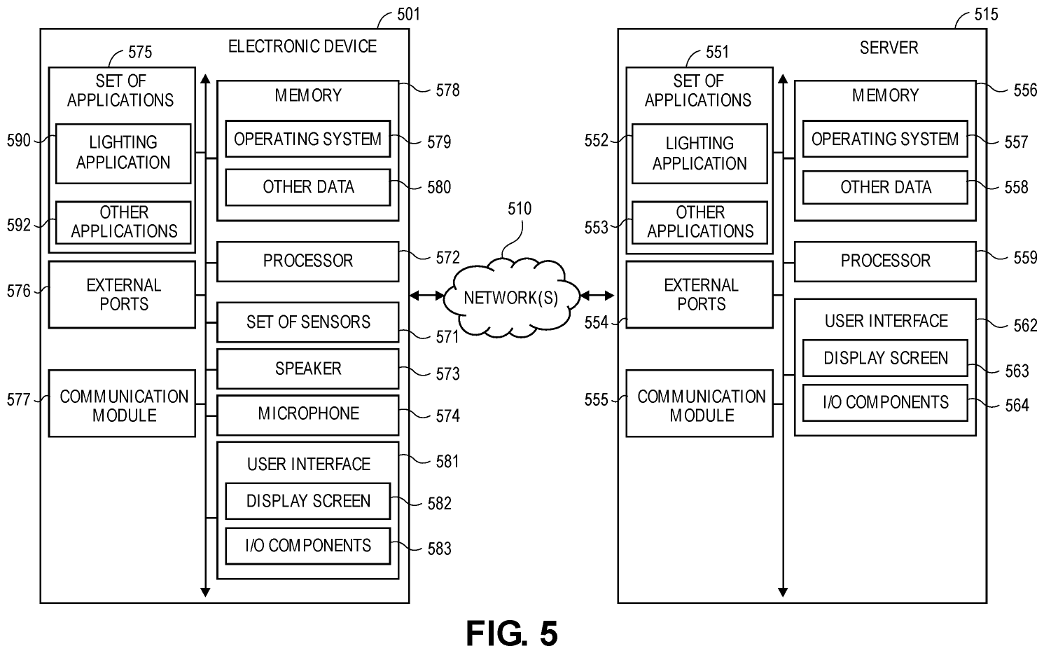

FIG. 5 illustrates a hardware diagram of an example electronic device 501 (e.g., one of the electronic devices 116, 117 as described with respect to FIG. 1) and an example server 515 (e.g., the server 115 as described with respect to FIG. 1), in which the functionalities as discussed herein may be implemented.

The electronic device 501 may include a processor 572 as well as a memory 578. The memory 578 may store an operating system 579 capable of facilitating the functionalities as discussed herein as well as a set of applications 575 (i.e., machine readable instructions). For example, one of the set of applications 575 may be a lighting application 590, such as to determine and assess lighting conditions based on data received from one or more light sensors, and control the operation of one or more light sources. It should be appreciated that one or more other applications 592 are envisioned.

The processor 572 may interface with the memory 578 to execute the operating system 579 and the set of applications 575. According to some embodiments, the memory 578 may also store other data 580 that may include data indicating certain ideal lighting conditions for certain plants, as well as characteristics of a set of light sources. The program(s) sitting in memory may also incorporate machine learning features and techniques that account for any previous actions taken by an administrator such that any subsequent actions are able to be taken automatically and without human intervention. The memory 578 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 501 may further include a communication module 577 configured to communicate data via one or more networks 510. According to some embodiments, the communication module 577 may include one or more transceivers (e.g., WAN, WWAN, WLAN, and/or WPAN transceivers) functioning in accordance with IEEE standards, 3GPP standards, or other standards, and configured to receive and transmit data via one or more external ports 576.

The electronic device 501 may include a set of sensors 571 such as, for example, a location module (e.g., a GPS chip), an image sensor, a light sensor(s), an accelerometer, a clock, a gyroscope (i.e., an angular rate sensor), a compass, a yaw rate sensor, a tilt sensor, telematics sensors, and/or other sensors. The electronic device 501 may further include a user interface 581 configured to present information to a user and/or receive inputs from the user. As shown in FIG. 5, the user interface 581 may include a display screen 582 and I/O components 583 (e.g., ports, capacitive or resistive touch sensitive input panels, keys, buttons, lights, LEDs, and/or built in or external keyboard). Additionally, the electronic device 501 may include a speaker 573 configured to output audio data and a microphone 574 configured to detect audio.

In some embodiments, the electronic device 501 may perform the functionalities as discussed herein as part of a “cloud” network or may otherwise communicate with other hardware or software components within the cloud to send, retrieve, or otherwise analyze data.

As illustrated in FIG. 5, the electronic device 501 may communicate and interface with the server 515 via the network(s) 510. The server 515 may include a processor 559 as well as a memory 556. The memory 556 may store an operating system 557 capable of facilitating the functionalities as discussed herein as well as a set of applications 551 (i.e., machine readable instructions). For example, one of the set of applications 551 may be a lighting application 552, such as to determine and assess lighting conditions based on data received from one or more light sensors, and control the operation of one or more light sources. It should be appreciated that one or more other applications 553 are envisioned.

The processor 559 may interface with the memory 556 to execute the operating system 557 and the set of applications 551. According to some embodiments, the memory 556 may also store other data 558 that may include data indicating certain ideal lighting conditions for certain plants, as well as characteristics of a set of light sources. The memory 556 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 515 may further include a communication module 555 configured to communicate data via the one or more networks 510. According to some embodiments, the communication module 555 may include one or more transceivers (e.g., WAN, WWAN, WLAN, and/or WPAN transceivers) functioning in accordance with IEEE standards, 3GPP standards, or other standards, and configured to receive and transmit data via one or more external ports 554.

The server 515 may further include a user interface 562 configured to present information to a user and/or receive inputs from the user. As shown in FIG. 5, the user interface 562 may include a display screen 563 and I/O components 564 (e.g., ports, capacitive or resistive touch sensitive input panels, keys, buttons, lights, LEDs, external or built in keyboard). According to some embodiments, the user may access the server 515 via the user interface 562 to review information, make selections, and/or perform other functions.

In some embodiments, the server 515 may perform the functionalities as discussed herein as part of a “cloud” network or may otherwise communicate with other hardware or software components within the cloud to send, retrieve, or otherwise analyze data. Further, in embodiments, the server 515 may support operation of a desktop or mobile application which may enable remote administration of the cloud data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processors 572, 559 (e.g., working in connection with the respective operating systems 579, 557) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate or additional embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

The following list of examples reflects a variety of the embodiments explicitly contemplated by the present disclosure:

Example 1. A computer-implemented method of assessing lighting conditions within a facility in which plants are grown, the computer-implemented method comprising: measuring, using at least one light sensor, a set of lighting conditions at a location of the facility; comparing, by a computer processor, the set of lighting conditions to a set of intended lighting conditions to determine that the set of lighting conditions differs from the set of intended lighting conditions by a threshold amount; generating, by the processor, a communication indicating that the set of lighting conditions differs from the set of intended lighting conditions by the threshold amount; and availing, by the processor, the communication for access by an electronic device.

Example 2. The computer-implemented method of example 1, wherein the processor is part of the electronic device, and wherein availing the communication for access by the electronic device comprises: displaying the communication in a user interface of the electronic device.

Example 3. The computer-implemented method of example 1 or 2, wherein generating the communication comprises: generating, by the processor, a visualization illustrating a set of differences between the set of lighting conditions and the set of intended lighting conditions.

Example 4. The computer-implemented method of any one of examples 1-3, wherein measuring the set of lighting conditions comprises: measuring, using the at least one light sensor, a spectral power distribution (SPD) at the location of the facility; wherein the set of intended lighting conditions is an intended SPD.

Example 5. The computer-implemented method of any one of examples 1-4, further comprising: determining, by the processor based at least on the set of lighting conditions, an action to adjust operation of a lighting component; and causing the lighting component to implement the action.

Example 6. The computer-implemented method of example 5, wherein causing the lighting component to implement the action comprises: transmitting, by the processor, a command associated with the action to the lighting component, wherein the lighting component executes the command to cause the lighting component to implement the action.

Example 7. The computer-implemented method of example 5, wherein determining the action to adjust the operation of the lighting component comprises: receiving, via the electronic device, a selection to adjust the operation of the lighting component; and generating, by the processor based on the selection, the action to adjust the operation of the lighting component.

Example 8. A system for assessing lighting conditions within a facility in which plants are grown, comprising: a memory storing a set of intended lighting conditions; at least one light sensor configured to measure a set of lighting conditions at a location of the facility; and a processor interfaced with the memory and the at least one light sensor, and configured to: access, from the at least one light sensor, the set of lighting conditions, compare the set of lighting conditions to the set of intended lighting conditions to determine that the set of lighting conditions differs from the set of intended lighting conditions by a threshold amount, generate a communication indicating that the set of lighting conditions differs from the set of intended lighting conditions by the threshold amount, and avail the communication for access by an electronic device.

Example 9. The system of example 8, wherein the electronic device comprises a user interface; and wherein the processor avails the communication by displaying the communication in the user interface.

Example 10. The system of example 8 or 9, wherein to generate the communication, the processor is configured to: generate a visualization illustrating a set of differences between the set of lighting conditions and the set of intended lighting conditions.

Example 11. The system of any one of examples 8-10, wherein the at least one light sensor measures a spectral power distribution (SPD) at the location of the facility, and wherein the set of intended lighting conditions is an intended SPD.

Example 12. The system of any one of examples 8-11, further comprising: a lighting component; wherein the processor is further configured to: determine, based at least on the set of lighting conditions, an action to adjust operation of the lighting component, and cause the lighting component to implement the action.

Example 13. The system of example 12, wherein to cause the lighting component to implement the action, the processor is configured to: transmit a command associated with the action to the lighting component, wherein the lighting component executes the command to cause the lighting component to implement the action

Example 14. The system of example 12, wherein to determine the action to adjust the operation of the lighting component, the processor is configured to: receive, via the electronic device, a selection to adjust the operation of the lighting component, and generate, based on the selection, the action to adjust the operation of the lighting component.

Example 15. A non-transitory computer-readable storage medium having stored thereon a set of instructions, executable by a processor, for assessing lighting conditions within a facility in which plants are grown, the instructions comprising: instructions for measuring, using at least one light sensor, a set of lighting conditions at a location of the facility; instructions for comparing the set of lighting conditions to a set of intended lighting conditions to determine that the set of lighting conditions differs from the set of intended lighting conditions by a threshold amount; instructions for generating a communication indicating that the set of lighting conditions differs from the set of intended lighting conditions by the threshold amount; and instructions for availing the communication for access by an electronic device.

Example 16. The non-transitory computer-readable storage medium of example 15, wherein the instructions for availing the communication for access by the electronic device comprise: instructions for displaying the communication in a user interface of the electronic device.

Example 17. The non-transitory computer-readable storage medium of either example 15 or 16, wherein the instructions for generating the communication comprise: instructions for generating a visualization illustrating a set of differences between the set of lighting conditions and the set of intended lighting conditions.

Example 18. The non-transitory computer-readable storage medium of any of examples 15-17, wherein the instructions for measuring the set of lighting conditions comprise: instructions for measuring, using the at least one light sensor, a spectral power distribution (SPD) at the location of the facility; wherein the set of intended lighting conditions is an intended SPD.

Example 19. The non-transitory computer-readable storage medium of any of examples 15-18, the instructions further comprising: instructions for determining, based at least on the set of lighting conditions, an action to adjust operation of a lighting component; and instructions for causing the lighting component to implement the action.

Example 20. The non-transitory computer-readable storage medium of example 19, wherein the instructions for causing the lighting component to implement the action comprise: instructions for transmitting a command associated with the action to the lighting component, wherein the lighting component executes the command to cause the lighting component to implement the action.

Example 21. A system for assessing conditions associated with plant growth, comprising: a memory storing a set of intended growing conditions; a plurality of sensors configured to measure a set of growing conditions at a respective plurality of locations; and a processor interfaced with the memory and the plurality of sensors, and configured to: access, from the plurality of sensors, the set of growing conditions, compare the set of growing conditions to the set of intended growing conditions to determine that the set of growing conditions differs from the set of intended growing conditions by a threshold amount, generate a communication indicating that the set of growing conditions differs from the set of intended growing conditions by the threshold amount, and avail the communication for access by an electronic device.

Example 22. A computer-implemented method of assessing nutrient conditions associated with plant growth in a facility, the computer-implemented method comprising: detecting, by at least one nutrient sensor respectively disposed at at least one location of the facility, a set of nutrient conditions associated with a set of plants being grown at the facility; comparing, by a processor, the set of nutrient conditions to a set of intended nutrient conditions associated with the set of plants; based on the comparing, determining, by the processor, to modify a set of nutrients added to an area in which the set of plants are being grown; and modifying the set of nutrients added to the area in which the set of plants are being grown.

What is claimed is:

1. A computer-implemented method of assessing lighting conditions within a facility in which plants are grown, the computer-implemented method comprising:
measuring, using at least one light sensor, a set of lighting conditions at a location of the facility;
comparing, by a computer processor, the set of lighting conditions to a set of intended lighting conditions to determine that the set of lighting conditions differs from the set of intended lighting conditions by a threshold amount;
generating, by the processor, a communication indicating that the set of lighting conditions differs from the set of intended lighting conditions by the threshold amount; and
availing, by the processor, the communication for access by an electronic device.

2. The computer-implemented method of claim 1, wherein the processor is part of the electronic device, and wherein availing the communication for access by the electronic device comprises:
displaying the communication in a user interface of the electronic device.

3. The computer-implemented method of claim 1, wherein generating the communication comprises:
generating, by the processor, a visualization illustrating a set of differences between the set of lighting conditions and the set of intended lighting conditions.

4. The computer-implemented method of claim 1, wherein measuring the set of lighting conditions comprises:
measuring, using the at least one light sensor, a spectral power distribution (SPD) at the location of the facility;
wherein the set of intended lighting conditions is an intended SPD.

5. The computer-implemented method of claim 1, further comprising:
determining, by the processor based at least on the set of lighting conditions, an action to adjust operation of a lighting component; and
causing the lighting component to implement the action.

6. The computer-implemented method of claim 5, wherein causing the lighting component to implement the action comprises:
transmitting, by the processor, a command associated with the action to the lighting component, wherein the lighting component executes the command to cause the lighting component to implement the action.

7. The computer-implemented method of claim 5, wherein determining the action to adjust the operation of the lighting component comprises:
receiving, via the electronic device, a selection to adjust the operation of the lighting component; and
generating, by the processor based on the selection, the action to adjust the operation of the lighting component.

8. A system for assessing lighting conditions within a facility in which plants are grown, comprising:
a memory storing a set of intended lighting conditions;
at least one light sensor configured to measure a set of lighting conditions at a location of the facility; and
a processor interfaced with the memory and the at least one light sensor, and configured to:
access, from the at least one light sensor, the set of lighting conditions,
compare the set of lighting conditions to the set of intended lighting conditions to determine that the set of lighting conditions differs from the set of intended lighting conditions by a threshold amount,
generate a communication indicating that the set of lighting conditions differs from the set of intended lighting conditions by the threshold amount, and
avail the communication for access by an electronic device.

9. The system of claim 8, wherein the electronic device comprises a user interface; and wherein the processor avails the communication by displaying the communication in the user interface.

10. The system of claim 8, wherein to generate the communication, the processor is configured to:
generate a visualization illustrating a set of differences between the set of lighting conditions and the set of intended lighting conditions.

11. The system of claim 8, wherein the at least one light sensor measures a spectral power distribution (SPD) at the location of the facility, and wherein the set of intended lighting conditions is an intended SPD.

12. The system of claim 8, further comprising:
a lighting component;
wherein the processor is further configured to:
determine, based at least on the set of lighting conditions, an action to adjust operation of the lighting component, and
cause the lighting component to implement the action.

13. The system of claim 12, wherein to cause the lighting component to implement the action, the processor is configured to:
transmit a command associated with the action to the lighting component, wherein the lighting component executes the command to cause the lighting component to implement the action.

14. The system of claim 12, wherein to determine the action to adjust the operation of the lighting component, the processor is configured to:
receive, via the electronic device, a selection to adjust the operation of the lighting component, and
generate, based on the selection, the action to adjust the operation of the lighting component.

15. A non-transitory computer-readable storage medium having stored thereon a set of instructions, executable by a processor, for assessing lighting conditions within a facility in which plants are grown, the instructions comprising:
instructions for measuring, using at least one light sensor, a set of lighting conditions at a location of the facility;
instructions for comparing the set of lighting conditions to a set of intended lighting conditions to determine that the set of lighting conditions differs from the set of intended lighting conditions by a threshold amount;
instructions for generating a communication indicating that the set of lighting conditions differs from the set of intended lighting conditions by the threshold amount; and
instructions for availing the communication for access by an electronic device.

16. The non-transitory computer-readable storage medium of claim 15, wherein the instructions for availing the communication for access by the electronic device comprise:
instructions for displaying the communication in a user interface of the electronic device.

17. The non-transitory computer-readable storage medium of claim 15, wherein the instructions for generating the communication comprise:
instructions for generating a visualization illustrating a set of differences between the set of lighting conditions and the set of intended lighting conditions.

18. The non-transitory computer-readable storage medium of claim 15, wherein the instructions for measuring the set of lighting conditions comprise:
instructions for measuring, using the at least one light sensor, a spectral power distribution (SPD) at the location of the facility;
wherein the set of intended lighting conditions is an intended SPD.

19. The non-transitory computer-readable storage medium of claim 15, the instructions further comprising:
instructions for determining, based at least on the set of lighting conditions, an action to adjust operation of a lighting component; and
instructions for causing the lighting component to implement the action.

20. The non-transitory computer-readable storage medium of claim 19, wherein the instructions for causing the lighting component to implement the action comprise:
instructions for transmitting a command associated with the action to the lighting component, wherein the lighting component executes the command to cause the lighting component to implement the action.
